(19) United States
(12) Patent Application Publication
(10) Pub. No.: US 2007/0274019 A1
(43) Pub. Date: Nov. 29, 2007

(54) Neutralization Apparatus

(75) Inventor: Yomatsu Nakajima, Tokyo (JP)

Correspondence Address: BIRCH STEWART KOLASCH & BIRCH, PO BOX 747, FALLS CHURCH, VA, 22040-0747, US

(73) Assignee: Hugle Electronics Inc., Tokyo (JP)

(21) Appl. No.: 10/593,391

(22) PCT Filed: Mar. 17, 2005
(86) PCT No.: PCT/JP05/05461

§ 371 Date: Sep. 19, 2006

(30) Foreign Application Priority Data
May 26, 2004 (JP) 2004-155807

(51) Int. Cl. H01T 23/00

(52) U.S. Cl. 361/231

(57) ABSTRACT

A neutralization apparatus 1 according to the present invention is a DC gas injection type neutralization apparatus which efficiently neutralizes a large subject to be neutralized at high speed without generating reverse electrification. Gas injection ports 60 are formed between plus electrodes 20 and minus electrodes 30. The plus electrodes 20 and the minus electrodes 30 respectively emit plus ions and minus ions toward gas flows from the gas injection ports 60, and the plus ions and minus ions reach the subject to be neutralized at high speed and neutralize the same.

### TECHNICAL FIELD

The present invention relates to a neutralization apparatus which neutralizes positive and negative static electricity on a surface of a subject to be neutralized by neutralizing the electricity by plus ions and minus ions generated by corona discharge.

### BACKGROUND ART

The mainstream of a conventional neutralization apparatus is a corona discharge neutralization apparatus. According to the conventional neutralization apparatus, high voltage is applied to a needle-like discharge electrode (discharge needle), plus ions and minus ions (hereinafter, plus ions and minus ions are collectively called only “ions”) are generated from air, a charged subject to be neutralized is irradiated with ions to neutralize the subject. One example of the subject to be neutralized is a plate-like glass substrate. The glass substrate is used for a TFT (thin film transistor) liquid crystal panel, a PDP (plasma display panel), an LCD (liquid crystal display) and the like.

Such corona discharge neutralization apparatuses are roughly divided into AC neutralization apparatuses using AC power supply as the high voltage power supply to be applied to the discharge needle, and a DC neutralization apparatus using DC power supply. Each neutralization apparatus has its characteristics, and it is necessary to select an apparatus according to a purpose of use.

The AC neutralization apparatus mainly uses a power supply voltage obtained by increasing commercial power supply by a step-up transformer, and plus ions and minus ions are alternately generated from one discharge needle. The generated ions are carried by air flow to increase the moving speed, thereby enhancing the neutralization effect.

The merit of the AC neutralization apparatus is that when the AC power supply is of 50 Hz, plus ions and minus ions are alternately generated from one discharge needle every 20 msec, and the plus ions and the minus ions equally exist in a space. Thus, even when ions are generated near the subject to be neutralized, reverse electrification (ions having the same polarity are collectively emitted to the same position, and a subject to be neutralized is charged with the ions) is less likely to be generated.

There are two drawbacks of the AC neutralization apparatus. The first drawback is that since plus ions and minus ions are close to each other, the probability that the plus ions and minus ions are re-coupled to each other is high, generated ions cannot reach a further position and are reduced. The second drawback is that since it is difficult to miniaturize a step-up transformer which increases commercial AC power supply, an ion generating unit and a high voltage power supply unit are separated from each other, the high voltage power supply unit disposed away from the ion generating unit, the ion generating unit and the high voltage power supply unit are connected to each other through a high voltage electric wire, and it is difficult to miniaturize the AC neutralization apparatus and to integrally form the AC neutralization apparatus.

A DC neutralization apparatus will be explained next with reference to the drawing. FIG. 11 shows a structure of a conventional DC bar-shaped neutralization apparatus. As shown in FIG. 11, the DC bar-shaped neutralization apparatus 200 includes a neutralization apparatus main body 201, plus discharge needles 202 and minus discharge needles 203. The neutralization apparatus main body 201 of a laterally long bar-shaped body, and a power supply voltage unit is also accommodated in the neutralization apparatus main body 201. The neutralization apparatus main body 201 includes the plus discharge needles 202 and the minus discharge needles 203, and the number of the plus discharge needles and the number of minus discharge needles are the same. The plus discharge needle 202 generates plus ions and the minus discharge needle 203 generates minus ions.

Another DC neutralization apparatus will be explained with reference to the drawing. FIG. 12 shows a structure of another conventional DC bar-shaped neutralization apparatus. As shown in FIG. 12, the DC bar-shaped neutralization apparatus 200′ includes a neutralization apparatus main body 201, plus discharge needles 202, minus discharge needles 203, an ion sensor 204, and sensor support bodies 205. The neutralization apparatus main body 201 is a laterally long bar-shaped body. A power supply voltage unit is also accommodated in the neutralization apparatus main body 201. The neutralization apparatus main body 201 has the plus discharge needles 202 and the minus discharge needles 203, and the numbers of the plus discharge needles and of the minus discharge needles are the same. The plus discharge needle 202 generates plus ions and the minus discharge needle 203 generates minus ions. The ion sensor 204 is a bar-like sensor having substantially the same length as that of the neutralization apparatus main body 201. The ion sensor 204 is mounted in parallel to a longitudinal direction of the neutralization apparatus main body 201 on the side of the tip end of the discharge needle by the sensor support bodies 205. An ion balance distribution is measured based on a signal detected by the ion sensor 204, and control is performed such that output amounts of the plus ions and minus ions are adjusted.

There are two merits of these DC bar-shaped neutralization apparatuses 200 and 200′. The first merit is that since the plus discharge needle 202 and the minus discharge needle 203 are sufficiently away from each other, the probability that the plus ions and minus ions are re-coupled to each other is lower than that of the AC neutralization apparatus, and ions can reach a further position. The second merit is that if high frequency voltage increased by a small high frequency transformer is rectified by a rectifier circuit, plus high voltage and minus high voltage can be obtained and thus, the small high voltage power supply unit can be employed in terms of structure, the high voltage power supply unit can be incorporated in the neutralization apparatus main body 201 which is the ion generating unit, and the DC bar-shaped neutralization apparatuses 200 and 200′ can be reduced in size and can be formed integrally.

On the other hand, the DC bar-shaped neutralization apparatuses 200 and 200′ have a drawback that, when a neutralization distance L from the plus discharge needle 202 and the minus discharge needle 203 (when both of them should be referred to, simply discharge needles) to the subject to be neutralized is short, density of plus ions is high in a space near the plus discharge needle 202 and density of minus ions is high in a space near the minus discharge needle 203 and thus, the DC bar-shaped neutralization apparatuses 200 and 200′ reversely electrify the subject to be neutralized with plus or minus partially.

The tendency of such reverse electrification will be explained with reference to the drawings. FIG. 13 is an explanatory diagram of an experiment apparatus for verifying the reverse electrification. FIG. 14 shows an ion balance distribution which is an experiment result. As shown in FIG. 13, under an environment where downflow flows, the DC bar-shaped neutralization apparatus 200 generates plus ions and minus ions, CPMs (charged plate monitors) were respectively disposed at A₀, A, B, C, D, E, and E₀ which were separated away from the DC bar-shaped neutralization apparatus 200 by a neutralization distance L (300 mm or 1000 mm), CPM voltage of each point was measured and the ion balance distribution was checked. This CPM has a size of the charged plate of 15 cm×15 cm, and its capacitance is 20 pF.

FIG. 14 shows the ion balance distribution of plus ions and minus ions in a neutralization range of the DC bar-shaped neutralization apparatus 200. In the ion balance distribution, the ion balance is adjusted such that the center (near C) of the neutralization apparatus main body 201 is 0V A CPM voltage on the side of a minus electrode (near A₀ and A) of the neutralization apparatus main body 201 is close to minus voltage, and a CPM voltage on the side of a plus electrode (near E₀ and E) of the neutralization apparatus main body 201 is close to plus voltage, and voltage gradient is as shown with a solid line in FIG. 14. As apparent from the ion balance distribution, the CPM voltage was high and neutralization was not perfect.

The reverse electrification receives (1) an influence of neutralization distance L and (2) an influence of neutralization positions A₀, A, B, C, D, E, and E₀.

In (1), the CPM voltage is totally higher where the neutralization distance from the discharge needle to the subject to be neutralized is short (L=300 mm) as compared with a case where the neutralization distance is long (L=1000 mm), and the tendency of the reverse electrification is strong. As the neutralization distance from the discharge needle to the subject to be neutralized becomes shorter, the tendency of the reverse electrification becomes stronger.

In (2), in the conventional DC bar-shaped neutralization apparatus 200, the tip end of the discharge needle is mounted such that it is oriented toward the subject to be neutralized, and the plus discharge needle 202 and the minus discharge needle 203 are separated from each other by a predetermined distance. Thus, the density of plus ions is high in a space near the plus discharge needle 202, the density of minus ions is high in a space near the minus discharge needle 203, and there is a drawback that the subject to be neutralized is partially reversely electrified with plus or minus. Particularly, the plus discharge needles 202 (right side in FIG. 13) are mounted on one end of the neutralization apparatus main body 201, and the minus discharge needles 203 (left side in FIG. 13) are mounted on the other end of the neutralization apparatus main body 201, and there is a tendency that the density of plus ions in the space near the end of the bar where the plus discharge needles 202 exist is remarkably higher than that of the central portion of the bar and the density if minus ions in the space near the bar end of the minus discharge needle 203 is remarkably higher than that of the central portion of the bar. Concerning the ion balance distribution of plus ions and minus ions in the neutralization range of the DC bar-shaped neutralization apparatus 200, the density of plus ions in the space near the end of the bar where the plus discharge needle 202 exists is remarkably higher than that of the bar central portion, and the density of the minus ions in the space near the bar end where the minus discharge needle 203 exists is remarkably higher than that of the bar central portion as shown in FIG. 14.

This tendency is also influenced by the neutralization distance L, and when the neutralization distance L from the discharge needle to the subject to be neutralized is short (L=300 mm), there is a tendency that the CPM voltage becomes high and the reverse electrification becomes stronger at the end.

Hence, to eliminate the reverse electrification, if the neutralization distance from the discharge needle to the subject to be neutralized is increased, a new problem is generated. This point will be explained with reference to the drawings. FIG. 15 is a characteristic diagram of neutralization time—position as an experiment result. As shown in FIG. 15, there is a tendency that if the neutralization distance L from the discharge needle to the subject to be neutralized is long, the neutralization time is long. As apparent from this, in the DC bar-shaped neutralization apparatus 200, there is a tendency that if the neutralization distance is shortened to shorten the neutralization time, the reverse electrification is generated, and if the neutralization distance is increased to eliminate the reverse electrification, the neutralization time is increased. These problems are tendencies which may be caused also in the DC bar-shaped neutralization apparatus 200′ shown in FIG. 12. In the conventional technique, the neutralization distance is appropriately adjusted.

The conventional DC neutralization apparatus is as described above.

Patent document 1 (Japanese Patent Application Laid-open No. 2001-155894, title of the invention “ionizer”) discloses another conventional DC neutralization apparatus. According to this conventional technique, air is injected from a position above an electrode so that ion can reach faster, in addition to the characteristics of the above-described DC neutralization apparatus.

In recent years, the subject to be neutralized is increased in size as the size of PDP display is increased, and it is necessary that the neutralization distance L is reduced to shorten the neutralization time, and the neutralization can be carried out without generating the reverse electrification. However, the conventional DC bar-shaped neutralization apparatus has the following problems (1) to (4) concerning the reduction of the neutralization time and prevention of reverse electrification.

(1) In the conventional DC bar-shaped neutralization apparatuses 200 and 200′ as shown in FIGS. 12 and 13, to prevent the reverse electrification, the electrode distance between the plus discharge needle 202 and the minus discharge needle 203 according to the neutralization distance from the discharge needle to the subject to be neutralized is adjusted so that the plus ions and minus ions are not concentrated on a specific position, thereby preventing the reverse electrification. According to this method, however, there exists no structure for easily adjusting the distance between the plus discharge needle 202 and the minus discharge needle 203, the current state corresponds to a large number of kinds and a small amount of generation in which the apparatus is generated while designing when an order is received, and it is difficult to enhance the production efficiency. Further, if the apparatus is once generated, it is difficult to change and adjust the apparatus, the apparatuses are generated one by one according to a particular order, it is unprofitable in terms of the design cost and generation cost, and it is difficult to employ the prevention of the reverse electrification by adjusting the distance.

(2) According to the DC bar-shaped DC bar-shaped neutralization apparatuses 200 and 200′, the bar-shaped neutralization apparatus main body 201 uses insulative resin material for the cover, the insulative resin material causes charging phenomenon by electrostatic induction by an electric field generated from the discharge needle. A cover surface near the plus discharge needle 202 is charged plus, and a cover surface near the minus discharge needle 203 is charged minus. Minus ions are attracted by the plus charged portion, and plus ions are attracted by the minus charged portion. As a result, ions generated by the discharge needle are attracted the amount of ions reached the subject to be neutralized is reduced, and the ion balance distribution having the gradient as shown in FIG. 14 is generated. It is necessary to prevent the reverse electrification for eliminating such a newly found generation cause of the reverse electrification.

(3) Further, in the DC bar-shaped neutralization apparatus 200′ on which the ion sensor 204 shown in FIG. 12 is mounted, the linear ion sensor 204 having the same length as that of the bar-shaped neutralization apparatus main body 201 is mounted by the sensor support body 205 such that the ion sensor 204 is in parallel to the neutralization apparatus main body 201 on the tip end side of the discharge needle, and the ion balance can also be adjusted. However, in recent years, there is a tendency that the PDP flat panel which is a glass substrate is increased in a widthwise direction of the subject to be neutralized as large as 2000 mm, the ion sensor 204 of the DC bar-shaped neutralization apparatus 200′ in FIG. 12 also becomes long, a reinforcing structure is required, and the mechanical structure cannot be simplified.

(4) A purpose of neutralization by the neutralization apparatus is to neutralize the charging of the subject to be neutralized to 0V. However, an area of a subject to be neutralized such as a flat panel display in recent years becomes large and the neutralization capacity is also large, the amount of accumulated electrification charge is increased. Therefore, it is difficult to make the charged material 0V within a short time using the conventional neutralization apparatus.

To shorten the neutralization time, while it is necessary to shorten the neutralization distance, it can promote the reverse electrification as explained above. To enhance the neutralization efficiency by generating ions by the gross, there is a method to increase voltage to be applied to the discharge needle, however, if the voltage is increased by ±20 kV or higher, there is a problem of leakage of high voltage due to deterioration of resistance to pressure of the insulative material, and the ion generating efficiency is not enhanced in proportion to the increase of voltage. Therefore, this is not an efficiency solving method. There is a method to increase the amount of ion by mounting a plurality of neutralization apparatuses; however, this is difficult in terms of cost.

As described above, a new method for coping with increase in neutralization time and neutralization capacity generated by the increase of a subject to be neutralized in size is required.

Therefore, the present invention has been archived to solve the problems, an object of the invention is to provide a DC gas injection type neutralization apparatus in which a DC method having a small re-coupling amount and generating ions by the gross is employed, a neutralization distance from a discharge needle to a subject to be neutralized is largely reduced, the neutralization time is shortened with respect to a large subject to be neutralized, both plus ions and minus ions can reach without deviating in position concerning reverse electrification caused when the neutralization distance is shortened, the reverse electrification is prevented, a large subject to be neutralized can be neutralized efficiently and quickly.

### DISCLOSURE OF THE INVENTION

To solve the above problems, the present invention provides a DC voltage corona discharge neutralization apparatus comprising a neutralization apparatus main body; a plurality of plus electrodes which are provided in the neutralization apparatus main body and to which plus voltage is applied to generate plus ions, a plurality of minus electrodes which are provided in the neutralization apparatus main body and to which minus voltage is applied to generate minus ions, and a plurality of gas injection ports which are formed in the neutralization apparatus main body and from which gas flow for transferring ions is injected, wherein the gas injection ports are provided between the plus electrodes and the minus electrodes.

The neutralization apparatus according to the present invention further comprises a metal conductive plate which is made of metal and which is not grounded, and the neutralization apparatus main body is made of insulative resin material, and the metal conductive plate covers outside of the neutralization apparatus main body.

The neutralization apparatus according to the present invention further comprises ion sensors which are disposed between the plus electrodes and the minus electrodes and which are provided in the neutralization apparatus main body, and which detect an ion balance state and output detection signals, and a central processing unit which adjusts plus voltage applied to the plus electrodes and/or minus voltage to be applied to the minus electrodes to control the ion balance based on the detection signals from the ion sensors, and the central processing unit includes a unit which increases positive voltage to be applied to the plus electrode and/or which increases negative voltage to be applied to the minus electrode into a positive value when the detection signal indicates that there are more minus ions than plus ions, and a unit which lowers positive voltage to be applied to the plus electrode and/or which lowers negative voltage to be applied to the minus electrode into a negative value when the detection signal indicates that there are more plus ions than minus ions, and the ion balance is adjusted to a zero balance.

The neutralization apparatus according to the present invention further comprises a setting unit which is connected to the central processing unit, and which sets a positive mode in which more plus ions than minus ions are generated or only plus ions are generated to bring the ion balance into an unbalanced state, or sets a negative mode in which more minus ions than plus ions are generated or only minus ions are generated to bring the ion balance into an unbalanced state, instead of a normal mode in which the ion balance is adjusted to zero balance, and the central processing unit includes a unit which increases positive voltage to be applied to the plus electrode and/or which increases negative voltage to be applied to the minus electrode into a positive value when the positive mode is set, and a unit which lowers positive voltage to be applied to the plus electrode and/or which lowers negative voltage to be applied to the minus electrode into a negative value when the negative mode is set, and the plus ions and minus ions are intentionally brought into an unbalanced state.

In the neutralization apparatus according to the present invention, the plus electrodes and the minus electrodes are respectively provided with discharge needles which are inclined toward the gas injection ports, the gas flow is injected from each of the gas injection ports in a direction substantially perpendicular to the subject to be neutralized, and an extension of the discharge needle of the plus electrode and an extension of the discharge needle of the minus electrode intersect with each other on the gas flow.

In the neutralization apparatus according to the present invention, each of the ion sensors is of a rod-like shape, a straight shaft direction of the ion sensor is parallel to a gas injection direction, and the straight shaft of the ion sensor is mounted such that the extension of the discharge needle of the plus electrode and the extension of the discharge needle of the minus electrode intersect with each other.

In the neutralization apparatus according to the present invention, both the plus electrode and minus electrode have the same mechanical structures, each of the plus electrode and the minus electrode includes an electrode holder which is an electrical insulator and which is mechanically connected to the neutralization apparatus main body, a conductive portion disposed in the electrode holder, and two discharge needles which are electrically connected to the conductive portion, and the two discharge needles are inclined in a form of a □-shape.

In the neutralization apparatus according to the present invention, an end plus electrode and an end minus electrode disposed on ends have the same mechanical structures, each of the end plus electrode and end minus electrode includes an electrode holder which is an electrical insulator and which is mechanically connected to the neutralization apparatus main body, a conductive portion disposed in the electrode holder, and one discharge needle which is electrically connected to the conductive portion, and the one discharge needle is inclined toward the gas injection port.

The present invention described above can provide a DC gas injection type neutralization apparatus which efficiently neutralizes a large subject to be neutralized at high speed without generating reverse electrification.

### BRIEF DESCRIPTION OF THE DRAWINGS

FIG. 1 are diagrams showing a structure of a neutralization apparatus according to a best mode for carrying out the invention, wherein FIG. 1(a) is a side view, FIG. 1(b) is a front view, and FIG. 1(c) is a bottom view.

FIG. 2 is a block diagram of an air system of the neutralization apparatus according to the best mode for carrying out the invention.

FIG. 3 is a block diagram of an electric system of the neutralization apparatus according to the best mode for carrying out the invention.

FIG. 4 is a sectional view of a structure of a plus electrode (minus electrode).

FIG. 5 is a sectional view of a structure of an end plus electrode (end minus electrode).

FIG. 6 is an explanatory diagram for explaining a principle of neutralization.

FIG. 7 is an explanatory diagram of a principle for preventing a reverse electrification by adjacent plus electrode and minus electrode.

FIG. 8 is an explanatory diagram of an experiment apparatus for verifying the reverse electrification.

FIG. 9 is a diagram showing an ion balance distribution as an experiment result.

FIG. 10 is a characteristic diagram of neutralization time—position as an experiment result.

FIG. 11 is a structural diagram of a conventional DC bar-shaped neutralization apparatus.

FIG. 12 is a structural diagram of another conventional DC bar-shaped neutralization apparatus.

FIG. 13 is an explanatory diagram of an experiment apparatus for verifying the reverse electrification.

FIG. 14 is a diagram showing an ion balance distribution as an experiment result.

FIG. 15 is a characteristic diagram of neutralization time—position as an experiment result.

### BEST MODES FOR CARRYING OUT THE INVENTION

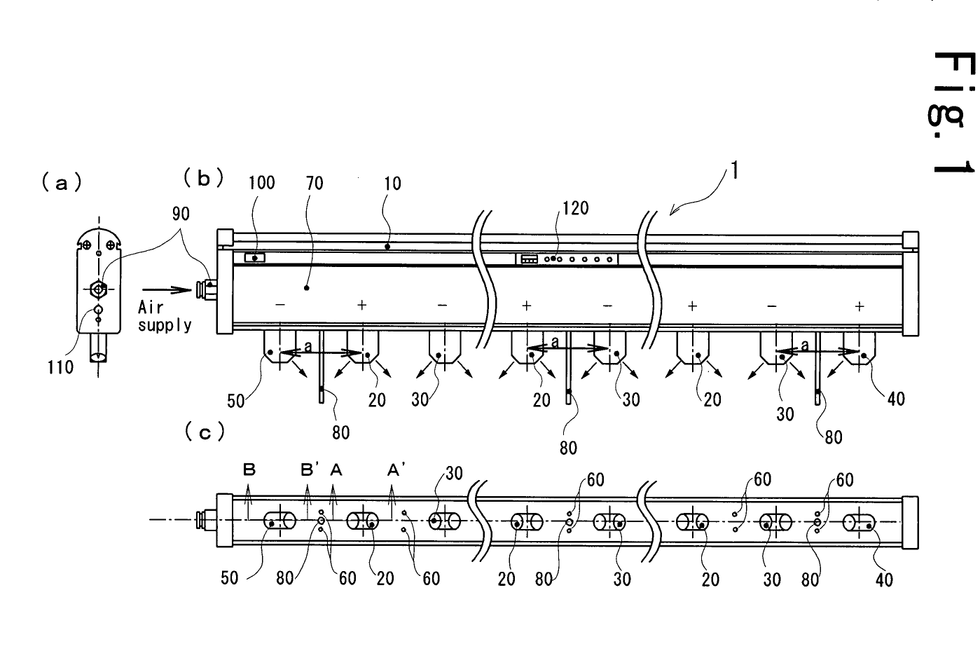

Best modes for carrying out the invention will be explained below based on the drawings. FIG. 1 are diagrams showing a structure of a neutralization apparatus according to a best mode for carrying out the invention, wherein FIG. 1(a) is a side view, FIG. 1(b) is a front view and FIG. 1(c) is a bottom view.

As shown in FIG. 1, as an exterior view, a neutralization apparatus 1 includes a neutralization apparatus main body 10, plus electrodes 20, minus electrodes 30, an end plus electrode 40, an end minus electrode 50, gas injection ports 60, a metal conductive plate 70, ion sensors 80, a gas introduction port 90, an external input/output terminal 100, a power supply voltage input terminal 110, and an operation display panel 120.

The neutralization apparatus main body 10 has a laterally long bar-like shape. The neutralization apparatus main body 10 is not limited to the bar-like shape, and various shapes such as a regular hexahedral shape, a regular hexahedral shape and a cylindrical shape can be employed.

The plurality of plus electrodes 20 are mounted on the neutralization apparatus main body 10, plus voltage is applied to the plus electrodes 20, and the plus electrode 20 generates plus ions in diagonal two directions (left and right diagonal downward directions in FIG. 1).

The plurality of minus electrodes 30 are mounted on the neutralization apparatus main body 10, minus voltage is applied to the minus electrodes 30, and the minus electrode 30 generates minus ions in diagonal two directions (left and right diagonal downward directions in FIG. 1).

The plus electrode 20 and the minus electrode 30 are separated away from each other by an electrode distance a.

The one end plus electrode 40 is mounted on the neutralization apparatus main body 10, plus voltage is applied to the end plus electrode 40 and the end plus electrode 40 generates plus ions in an inner diagonally one direction (left diagonally downward direction in FIG. 1). The end plus electrode 40 and the minus electrode 30 are separated away from each other by the electrode distance a.

The one end minus electrode 50 is mounted on the neutralization apparatus main body 10, minus voltage is applied to the end minus electrode 50 and the end minus electrode 50 generates minus ions in an inner diagonally one direction (right diagonally downward direction in FIG. 1). The end minus electrode 50 and the plus electrode 20 are separated away from each other by the electrode distance a.

The gas injection ports 60 are formed in substantially intermediate portions between the end minus electrode 50 and the plus electrode 20, substantially intermediate portions between the plus electrode 20 and the minus electrode 30, and substantially intermediate portions between the minus electrode 30 and the end plus electrode 40. The gas injection port 60 injects gas flow directly below the gas injection port 60. This gas flow is a clean air flow from which dust is removed by a filter. In the present embodiment, as shown in FIG. 1(c), two gas injection ports 60 are formed at the same positions, and the number of ports can appropriately be adjusted.

The metal conductive plate 70 is a conductive metal plate, and covers outside of the neutralization apparatus main body 10 which is made of insulative resin material. In the case of a structure having no metal conductive plate 70, electrostatic induction electrification by electric fields of the plus electrodes 20 and the minus electrodes 30 is generated on a surface of the insulative resin neutralization apparatus main body 10, plus electrification and minus electrification are alternately distributed partially on the neutralization apparatus main body 10, and the ion balance is partially influenced along the longitudinal direction of the neutralization apparatus main body 10.

Hence, the thin metal conductive plate 70 is pasted on the resin surface of the neutralization apparatus main body 10, the electrostatic induction electrification charge by the electric fields of the plus electrodes 20 and the minus electrodes 30 flows through the metal conductive plate 70 and is neutralized, the entire neutralization apparatus main body 10 in the longitudinal direction has the same potential, the partial influence of the ion balance is eliminated, and the entire neutralization apparatus main body 10 in the longitudinal direction can equally be controlled in ion balance.

When the metal conductive plate 70 is grounded, the uniform ion balance control can be performed, but a portion of the plus ions generated in the plus electrode 20 and a portion of minus ions generated in the minus electrode 30 are absorbed by the metal conductive plate 70 and flow to the ground and this influences the neutralization speed. Therefore, the metal conductive plate 70 is not grounded. As a result, the neutralization speed is not influenced by the metal conductive plate 70, and the ion balance can be uniformed over the entire longitudinal direction of the bar.

The ion sensors 80 are disposed between the plus electrodes 20 and the minus electrodes 30, and detect the ion balance state and outputs detection signals. The ion sensor 80 is of a bar-like shape, and is mounted such that the straight shaft direction of the ion sensor 80 is in parallel to the gas injection direction.

The gas introduction port 90 outputs supply air from outside.

The external input/output terminal 100 is a connector and receives a communication signal from outside.

The power supply voltage input terminal 110 is a 4P modular connector for +12 V input, and outputs power supply voltage Vₛ from outside.

The operation display panel 120 displays the operation state.

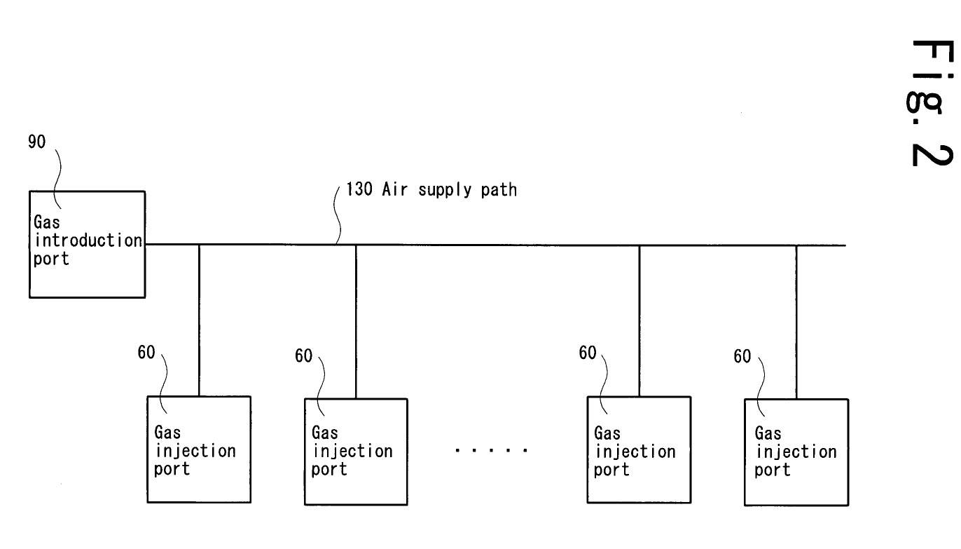

Next, the air system of the neutralization apparatus 1 will be explained. FIG. 2 is a block diagram of an air system of the neutralization apparatus 1. As shown in FIG. 2, in the air system, an air supply path 130 is connected to the gas introduction port 90, and the plurality of gas injection ports 60 are connected to the air supply path 130. Supply air that is compressed air is introduced into the air system, and air flow is output from the gas injection port 60.

Next, the electric system of the neutralization apparatus 1 will be explained. FIG. 3 is a block diagram of the electric system of the neutralization apparatus 1. As shown in FIG. 3, the electric system of the neutralization apparatus 1 is divided into a power supply system, a signal processing system, and a discharging system.

The power supply system includes the power supply voltage input terminal 110 and a power supply voltage generating unit 140.

The signal processing system includes a setting unit 160, the external input/output terminal 100, a central processing unit 150, and ion sensors 80.

The discharging system includes the plus electrodes 20, the minus electrodes 30, the end plus electrode 40, and the end minus electrode 50.

If power supply voltage V_{S} (for example, +12V) is input to the power supply voltage generating unit 140 through the power supply voltage input terminal 110, the power supply voltage generating unit 140 generates low voltage power supply (for example, +5V), plus high voltage power supply +V_{H} (for example, +3 kV to +7 kV), and minus high voltage power supply −V_{H} (for example, −3 kV to −7 kV), and supplies the low voltage power supply V_{L} to the signal processing system, and supplies high voltage power supply +V_{H}, and minus high voltage power supply −V_{H} to the discharging system. Particularly, high voltage is applied to the discharging system through a current limiting resistor.

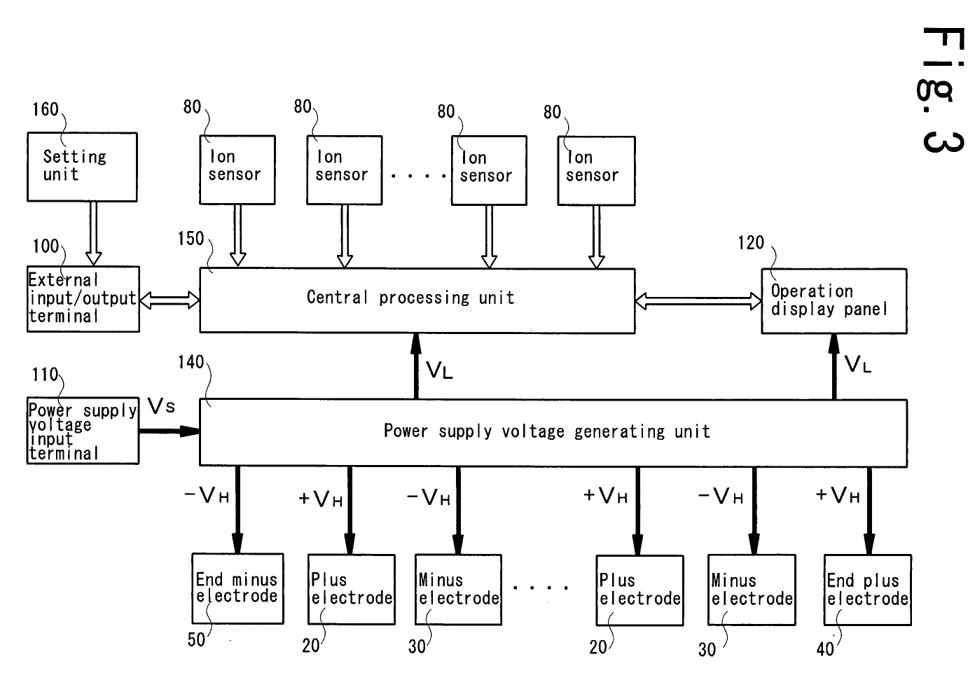

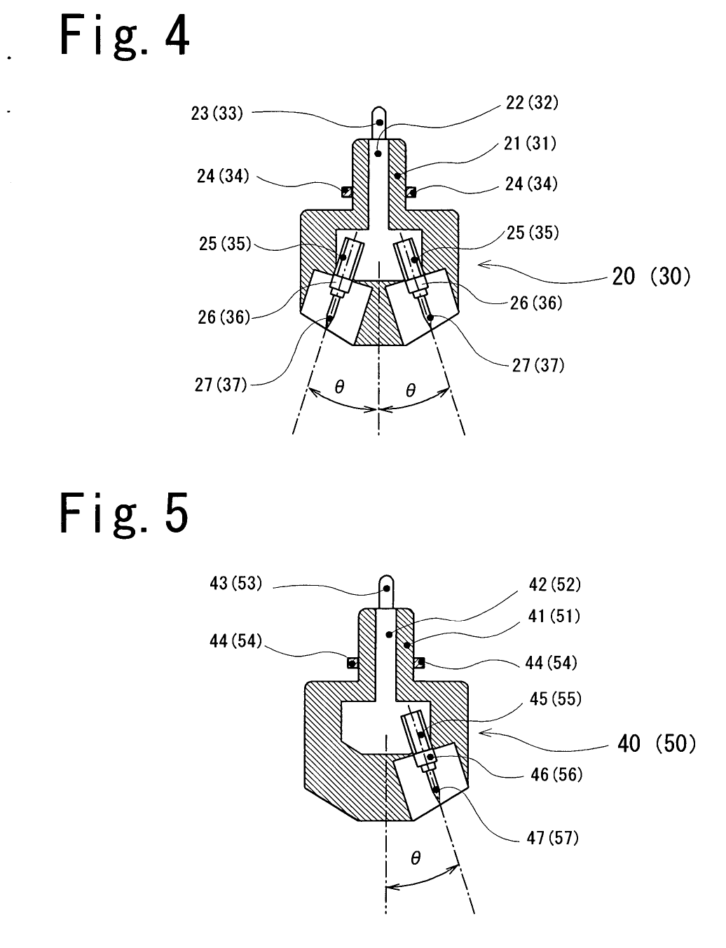

Next, a structure of the electrode will be explained. FIG. 4 is a sectional view of a structure of the plus electrode 20 (minus electrode 30). FIG. 4 is a sectional view taken along the A-A′ line in FIG. 1. As shown in FIG. 4, each plus electrode 20 includes an electrode holder 21, a conductive portion 22, a connection pin 23, a rotation stopper 24, connector screws 25, connectors 26, and discharge needles 27. Each minus electrode 30 has the same structure as that of the plus electrode 20, and includes an electrode holder 31, a conductive portion 32, a connection pin 33, a rotation stopper 34, connector screws 35, connectors 36, and discharge needles 37. The electrode structure of only the plus electrode 20 will be explained. The same names are used for parts of the minus electrode 30 and redundant explanation thereof will be omitted.

The conductive portion 22 is made of electrically conductive metal, and is provided with two female threads and the one connection pin 23 to which the power supply voltage generating unit 140 is electrically connected. The electrode holder 21 is made of insulative resin, the electrode holder 21 cover the conductive portion 22 such that only the connection pin 23 and the two female threads are exposed, and the electrode holder 21 has two bottomed holes into which the two female threads are accommodated. The discharge needles 27 are mounted on the connectors 26 formed with the connector screws 25, the connector screws 25 are threadedly inserted into the two female threads of the conductive portion 22 in the two bottomed holes, and the two discharge needles 27 are accommodated therein in a state where the discharge needles 27 are electrically connected to the conductive portion 22. The two discharge needles 27 are inclined outward with respect to the vertical axis by an angle θ. When the plus electrode 20 is mounted on the neutralization apparatus main body 10 as shown in FIG. 1, if the rotation stopper 24 and the plus electrode 20 are inserted into the neutralization apparatus main body 10 and are rotated by 90°, it is prevented from rotating by the rotation stopper 24 and is fixed, and the connection pin 23 is electrically connected to the power supply voltage generating unit 140 of the neutralization apparatus main body 10 at the same time.

Next, the outermost electrode structure of the neutralization apparatus main body 10 will be explained. FIG. 4 is a sectional view of the structure of the end plus electrode 40 (end minus electrode 50). The end minus electrode 50 corresponds to the cross section taken along the B-B′ line in FIG. 1, and the end plus electrode 40 is symmetric with FIG. 5. As shown in FIG. 5, the end plus electrode 40 includes an electrode holder 41, a conductive portion 42, a connection pin 43, a rotation stopper 44, a connector screw 45, a connector 46, and a discharge needle 47. The end minus electrode 50 has the same structure as that of the end plus electrode 40, and includes an electrode holder 51, a conductive portion 52, a connection pin 53, a rotation stopper 54, a connector screw 55, a connector 56, and a discharge needle 57. According to the electrode structure of each of the end plus electrode 40 and end minus electrode 50, the discharge needles 27 of the plus electrode 20 explained above are formed into a single needle. As shown in FIG. 1, the discharge needles 47 and 57 are disposed such as to be inclined in the direction of the arrow (inward) together with the end plus electrode 40 and the end minus electrode 50. Except this portion, the end plus electrode 40 and the end minus electrode 50 have the same structure and the same function, and the same names are used for the same parts, and redundant explanation will be omitted.

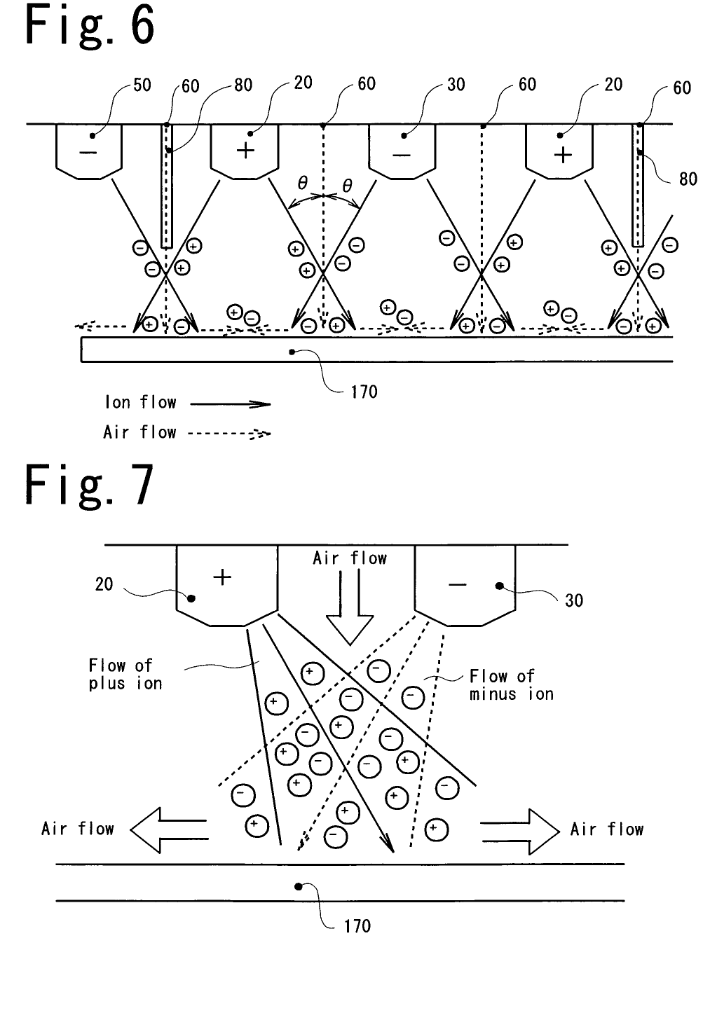

The principle of neutralization will be explained next. FIG. 6 is an explanatory diagram for explaining the principle of neutralization. FIG. 7 is an explanatory diagram of a principle for preventing a reverse electrification by the adjacent plus electrode and minus electrode.

As shown in FIGS. 1 and 6, in the neutralization apparatus main body 10, the plus electrodes 20 and the minus electrode 30 are alternately disposed. The discharge needles of the electrodes are disposed such that the extension of the discharge needle 27 of the plus electrode 20 and the extension of the discharge needle 37 of the minus electrode 30 intersect with each other on the air flow from the gas injection port 60. The inclination angle of the extension is θ.

As described above, the plus electrodes 20 and the minus electrodes 30 are inclined, and the plus ions and minus ions generated near the electrodes 20 and 30 approach each other by the Coulomb force. As shown in FIG. 7, the plus ions and minus ions are mixed with each other in the intermediate region. Usually, the plus high voltage power supply +V_{H} and minus high voltage power supply V_{H} are adjusted such that the plus ions and minus ions are generated without being deviated. Thus, there is no deviation in plus and minus. Air flow is injected at high speed from the gas injection port 60 to the intermediate region having no deviation in plus and minus and ions are sprayed to a subject to be neutralized 170. Therefore, the plus ions and minus ions reach without deviation, and neutralization is carried out without reverse electrification. Further, since ions flow together with the air flow along a surface of the subject to be neutralized 170, the electrification is carried out entirely without deviation except both ends of the bar. As shown in FIG. 6, the plus electrodes 20 and minus electrodes 30 are alternately disposed and the gas injection ports 60 are disposed between the plus electrodes 20 and minus electrodes 30. Therefore, the plus ions and minus ions reach without deviation entirely, neutralization can be carried out without reverse electrification.

Concerning the ion balance in spaces outside of both ends of the neutralization apparatus main body 10, there is a tendency that there are many plus ions on the side of the plus electrode the subject to be neutralized is charged positively electricity and there are many minus ions outside of the minus electrode and the subject to be neutralized is charged negatively electricity. Thus, in the neutralization apparatus 1 according to the present embodiment, of the two discharge needles of the plus electrode 20 and minus electrode 30 in the end plus electrode 40 and the end minus electrode 50, the discharge needle directed outward of an end surface of the neutralization apparatus main body 10 is eliminated, and the number of discharge needle directed inward is one. As a result, unnecessary ions are not generated toward the outside of the end of the subject to be neutralized 170 and thus, there are no excessive ions, a region where plus ions and minus ions are deviated does not appear in the entire neutralization apparatus main body 10 in the lateral direction and thus, it is possible to suppress the tendency of reverse electrification which frequently generated outside in the conventional technique.

Next, processing by the signal processing system will be explained. As shown in FIG. 1, in a state where the ion sensors 80 are disposed between the plus electrodes 20 and minus electrodes 30, the ion sensors 80 are suspended toward the subject to be neutralized 170, and the ion sensor 80 detect the ion balance state and output detection signals.

The central processing unit 150 adjusts the plus high voltage power supply +V_{H} to be applied to the plus electrode 20 and end plus electrode 40, and adjust the minus high voltage power supply −V_{H} to be applied to the minus electrode 30 and end minus electrode 50 so as to control the ion balance based on the detection signals from the ion sensors 80.

When the central processing unit 150 determines that the subject to be neutralized 170 is charged negatively in the deviation manner or determines that minus ions are generated more than plus ions from the detection signal, the plus high voltage power supply +V_{H} to be applied to the plus electrode 20 and end plus electrode 40 is more increased to high voltage (for example, the voltage is increased from +3 kV to +5 kV), or minus high voltage power supply −V_{H} to be applied to the minus electrode 30 and end minus electrode 50 is increased to positive high voltage (for example, increased from 5 kV to 3 kV), thereby reducing the minus ions. If one or both of the above are carried out, it is possible to increase the plus ions and to balance the plus and minus, the ion balance is adjusted to zero balance, and the subject to be neutralized 170 can be neutralized.

Similarly, when it is determined that the subject to be neutralized 170 is charged positively or it is determined that plus ions are more generated from the detection signal, the plus high voltage power supply +V_{H} to be applied to the plus electrode 20 and end plus electrode 40 is reduced (for example, from +5 kv to +3 kV), and the plus ions are reduced. Further, the minus high voltage power supply −V_{H} to be applied to the minus electrode 30 and end minus electrode 50 is more reduced to low voltage of negative value (for example, from 3 kV to 5 kV), and the minus ions are increased. If one or both of the above are carried out, it is possible to increase the plus ions and to balance the plus and minus, the ion balance is adjusted to zero balance, and the subject to be neutralized 170 can be neutralized.

In the present embodiment, the setting unit 160 can variously set in the central processing unit 150. This setting unit 160 can employ various modes. For example, the setting unit 160 can utilize a radio remote control sending, and has a function to freely increase or reduce the plus high voltage power supply +V_{H} to be applied to the plus electrode 20 and minus high voltage power supply −V_{H} to be applied to the minus electrode 30.

The subject to be neutralized 170 such as a flat panel display of the LCD or PDP in recent years is a glass whose one side length is 2000 mm or longer. The amount of electric charge generated in the manufacturing step and accumulated in the glass becomes lager in proportional to the area of the glass. Therefore, according to the conventional neutralization apparatus, it is difficult to neutralization to a value close to 0 v in a short time. However, it is known that the subject to be neutralized 170 such as a glass is charged with one of plus and minus in a predetermined manufacturing step.

For example, in the convention DC bar-shaped neutralization apparatus 200′ shown in FIG. 12, the ion sensor 204 detects the electrification value and polarity of the subject to be neutralized, the detection signal is fed back, and when it is charged positively, more minus ions are output and when it is charged negatively, more plus ions are output, thereby increasing the neutralization speed. However, in the actual manufacturing step of the LCD or the like, the time during which the glass passes through the neutralization region of the DC bar-shaped neutralization apparatus 200′ is about several seconds. Therefore, even if the ions of polarity opposite from the charged value are increased after the charged value is detected by the ion sensor 204, since ht moving speed of the subject to be neutralized is fast, and it is impossible to neutralize the subject to be neutralized to a value close to 0V in terms of time.

According to the neutralization apparatus 1 according to the present invention, when it is previously known that the subject to be neutralized is charged positively, more minus ions than plus ions are always output so that the space is charged negatively, and when the positively charged subject to be neutralized 170 passes through the neutralization region, minus ions fully dispersed in the space are attracted and the subject to be neutralized is neutralized to a value close to 0V. The density of plus ions or minus ions in the neutralization region space can be controlled in several stages such that an appropriate ion amount is obtained by previously determining whether the charging amount of subject to be neutralized 170 is large or small.

Therefore, the neutralization apparatus 1 can change the setting of the central processing unit 150 by the setting unit 160 connected to the external input/output terminal 100. Usually, a normal mode in which the ion balance is automatically adjusted to zero balance is selected, but it is possible to establish the unbalanced state by setting the state to a positive mode or negative mode.

In the positive mode, minus ions more than the plus ions are generated, or only plus ions are generated to bring the ion balance to unbalance.

In the negative mode, minus ions more than plus ions are generated or only minus ions are generated to bring the ion balance to unbalance.

When the positive mode is selected, the central processing unit 150 further increases the positive voltage to be applied to the plus electrode 20 and end plus electrode 40 (for example, increases the voltage from +3 kV to +5 kV) to increase the plus ions. The negative voltage to be applied to the minus electrode 30 and end minus electrode 50 is increased to the positive high voltage (for example, increases the voltage from −5 kV to −3 kV) to reduce the minus ions. If one or both of them are carried out, the plus ions are increased, and the plus ions and minus ions are intentionally adjusted to an unbalance value.

When the negative mode is selected, the central processing unit 150 reduces the positive voltage to be applied to the plus electrode 20 and end plus electrode 40 to a lower voltage (for example, reduces from +5 kV to +3 vK), in order to reduce the plus ions. Alternatively, the negative voltage to be applied to the minus electrode 30 and end minus electrode 50 is reduced to negative high voltage (for example, reduces from −3 kV to −5 kV) to increase the minus ions. If one or both of them are carried out, the plus ions are increased, and the plus ions and minus ions are intentionally adjusted to an unbalance value.

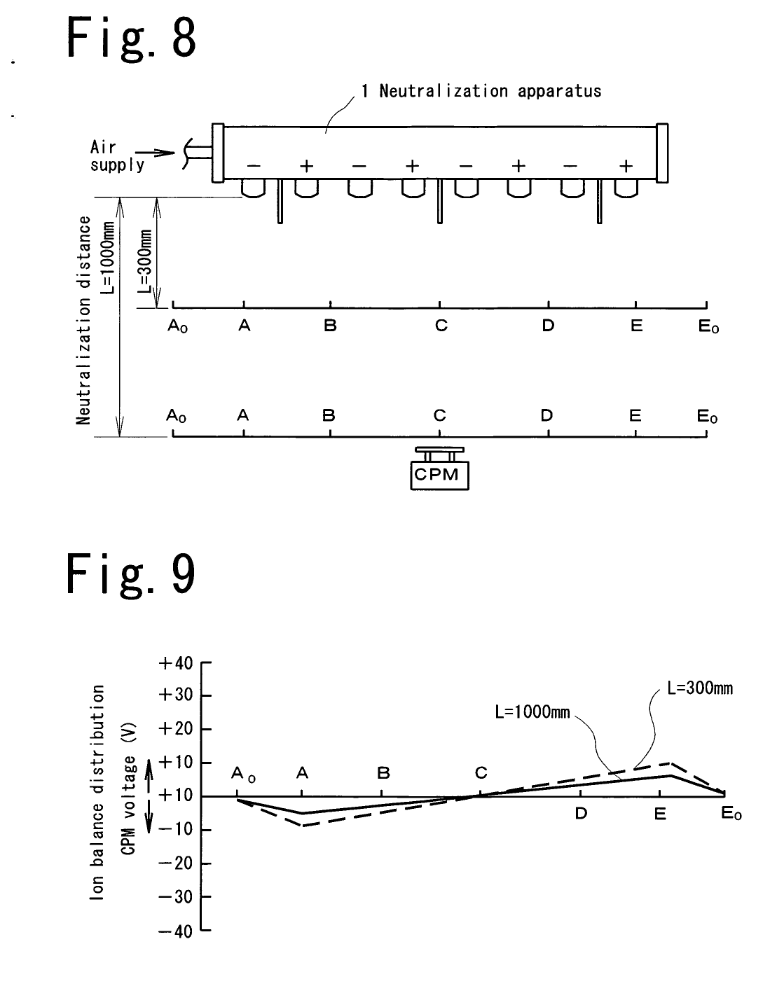

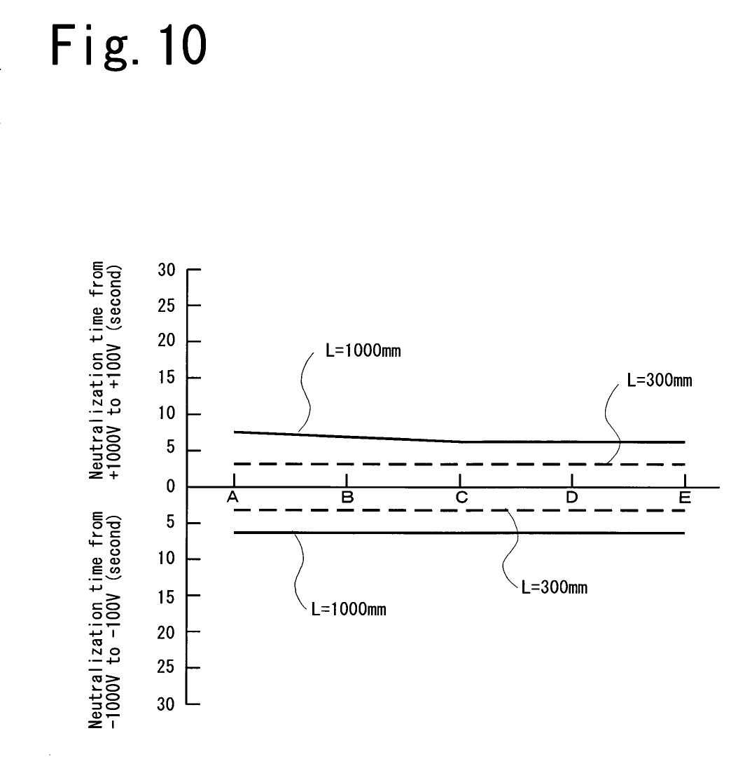

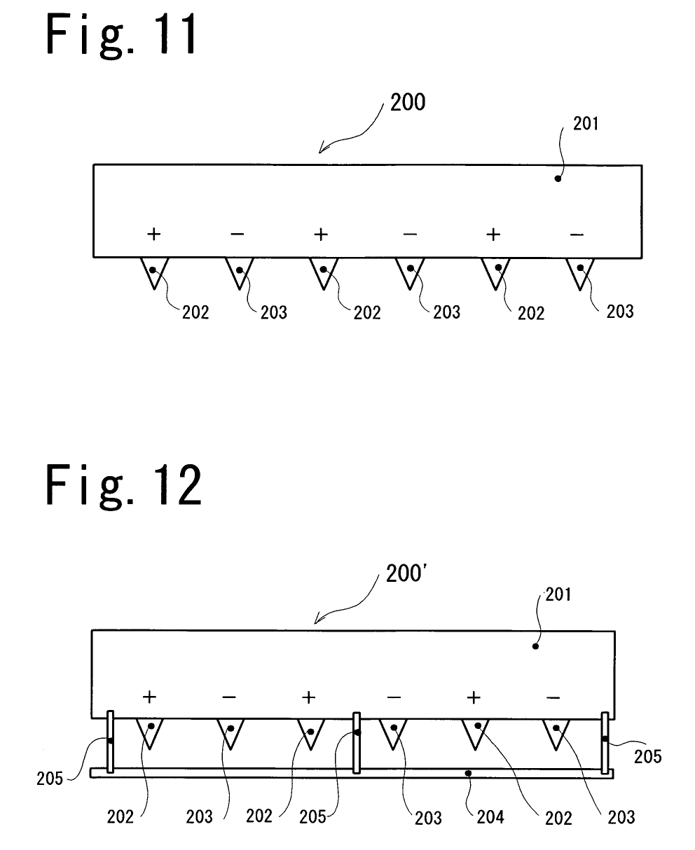

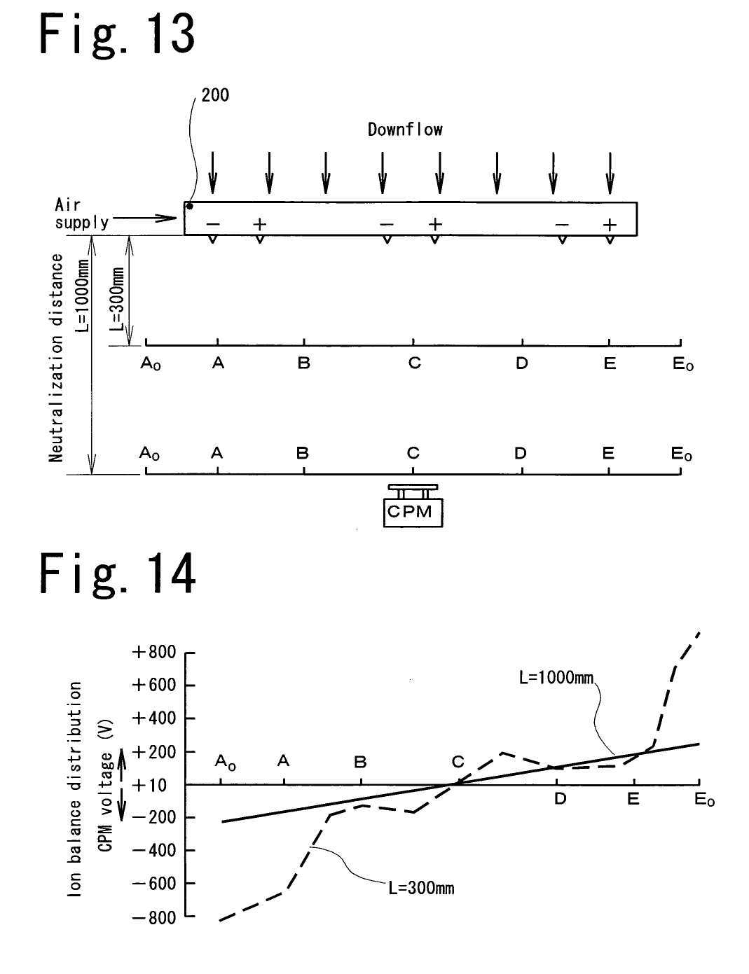

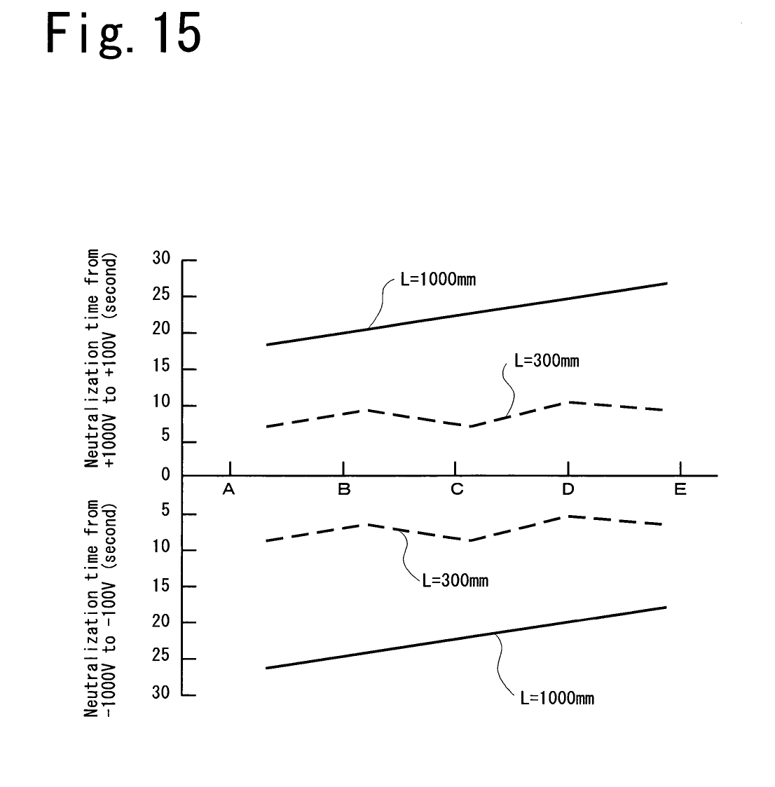

Next, the tendency of suppressing of reverse electrification by the neutralization apparatus 1 according to the embodiment will be explained with reference to drawings. FIG. 8 is an explanatory diagram of an experiment apparatus for verifying the reverse electrification. FIG. 9 is a diagram showing an ion balance distribution as an experiment result. FIG. 10 is a characteristic diagram of neutralization time—position as an experiment result. As shown in FIG. 8, the neutralization apparatus 1 was allowed to generate plus ions and minus ions, the CPMs (charged plate monitors) were respectively disposed at A₀, A, B, C, D, E, and E₀ separated away by the neutralization distance L=300 mm or 1000 mm, the CPM voltage of each point was measured and the ion balance distribution was checked. This CPM has the size of the charged plate of 15 cm×15 cm and the capacitance is 20 pF. This experiment apparatus is the same as that shown in FIG. 13.

FIG. 9 shows the ion balance distribution of plus ions and minus ions in the neutralization range of the neutralization apparatus 1. As apparent from the ion balance distribution, there is a tendency that the CPM voltage when the neutralization distance from the discharge needle to the subject to be neutralized is long (L=1000 mm) and the CPM voltage when the neutralization distance from the discharge needle to the subject to be neutralized is short (L=300 mm) are substantially equal to each other, and the reverse electrification is suppressed even when the distance is short. This is because, since the ions reach at high speed before the plus ions and minus ions are re-coupled to each other, the influence of long or short neutralization distance is eliminated.

In the A₀, A, B, C, D, E, and E₀, there is a tendency that the CPM voltage is high at A and E which are ends of the subject to be neutralized 170, but the voltage is in a range of +10V to −10V, and if this is compared with the CPM voltage of +800V to −800V of the conventional technique shown in FIG. 13, the generation of the reverse electrification is eliminated even with the neutralization distance of 300 mm, and the ion balance is remarkably improved.

Further, since the reverse electrification is not generated and a large amount of ions reach the discharging system at high speed with the air flow, the neutralization time can be reduced, and as shown in FIG. 10, even if the neutralization distance from the discharge needle to the subject to be neutralized is long, the neutralization time is sufficiently short (about 9 seconds), and since the neutralization distance is shortened, the neutralization time is further reduced, and desired neutralization can be achieved within a short time (about 4 seconds).

The neutralization apparatus 1 according to the embodiment has been explained above. In the present embodiment, the ion generating system of the neutralization apparatus 1 having the bar-shaped neutralization apparatus main body 10 is the DC system in which the probability of the ion reverse electrification-coupling is low, the generated plus ions and minus ions are mixed and they are sprayed to the subject to be neutralized 170 by the air flow, and even if the distance between the subject to be neutralized 170 and the neutralization apparatus main body 10 is shortened, the partial electrification by the DC bar-shaped neutralization apparatus is remarkably small as compared with the conventional apparatus. Thus, while maintaining the ion balance distribution being uniform, it is possible to shorten the neutralization time and to cope with the increasing tendency of the subject to be neutralized.

Next, the present invention will be explained based on a first example, which is much similar to an actual mode.

In the neutralization apparatus 1 shown in FIG. 1, the electrode disposition distance a between the plus electrode 20 and the minus electrode 30 is set to about 40 to 50 mm, the neutralization distance L from the plus electrode 20 (minus electrode 30) to the subject to be neutralized 170 is set to 300 mm, the diameter of the gas injection port 60 is set to 0.3 mm, gas having high flow rate is injected and ions reach the subject to be neutralized 170 quickly. In the apparatus according to the embodiment of the present invention, the distance between the plus electrode 20 and minus electrode 30 is short as compared with the conventional DC bar-shaped neutralization apparatus 200. In the conventional DC bar-shaped neutralization apparatuses 200 and 200′, the electrode distance a between the plus electrode 20 and the minus electrode 30 is longer than a predetermined distance to prevent the re-coupling of the ions. However, in return for this, the attraction force between the plus ions and minus ions is weak, the plus ions region and the minus ions region are formed, and when the neutralization distance L from the subject to be neutralized is about 300 mm, plus and minus reverse electrification is locally generated, and this affects the subject to be neutralized 170.

On the other hand, in the present embodiment, the discharge needle 27 of the plus electrode 20 continuously applies plus high voltage power supply +V_{H}, the discharge needle 37 of the minus electrode 30 continuously applies minus high voltage power supply −V_{H}, the tip ends of the discharge needles 27 and 37 generate the corona discharge to ionize the molecule in the air, plus ions are generated near the plus discharge needle 27, and minus ions are generated near the minus discharge needle 37. The generated plus ions and minus ions are absorbed and collected to the intermediate region, the plus ions and minus ions in the intermediate region are simultaneously transferred by the air flow and thus, plus and minus partial reverse electrification is not generated almost at all even with a short distance. Further, since gas is injected from the very small hole having the diameter of 0.3 mm, the re-coupling ratio of plus ions and minus ions is extremely low, ions can be transferred with excellent balance and neutralization can be carried out efficiency even if the neutralization distance is as long as 1500 to 2000 mm. If the pressure of the supply air introduced into the neutralization apparatus main body 10 is adjusted, the ion transfer speed can freely be controlled. Therefore, it is possible to realize the neutralization ability with respect to a using place.

The neutralization apparatus 1 has the ion sensors 80 for automatically controlling the variation of the ion balance. Each ion sensor 80 is disposed at the intermediate point between the discharge needle 27 of the plus electrode 20 and the discharge needle 37 of the minus electrode 30. The ion sensor 80 is a metal rod having a diameter of 2 to 3 mm and a length of 40 to 50 mm, and the mounting angle is parallel to the flow direction (vertical direction) of the air flow of the injected gas. The number of the ion sensors 80 is three, i.e., one ion sensor 80 at the center of the neutralization apparatus main body 10 and at the intermediate point between the plus electrode 20 and the minus electrode 30, one ion sensor 80 at the intermediate point between the end minus electrode 50 and the minus electrode 30, and one ion sensor 80 at the intermediate point between the minus electrode 30 and the end plus electrode 40. With this configuration, it is possible to automatically control such that the inclination of the ion balance of the entire neutralization apparatus main body 10 in the lateral direction in a substantially uniformly distributed state. The ion sensor 80 is threadedly inserted into the neutralization apparatus main body 10, and this structure is inexpensive and economical.

The metal conductive plate of the neutralization apparatus 1 is made of stainless steel having both side surface thickness of 0.3 mm, and the neutralization apparatus 1 is pasted on the insulative resin neutralization apparatus main body 10. The electrostatic induction electrification charge by the electric fields of the plus discharge needle 27 of the plus electrode 20 and the minus discharge needle 37 of the minus electrode 30 flows through the metal conductive plate 70 and is neutralized, the entire neutralization apparatus main body 10 in the lateral direction has the same potential, the ion balance is not partially influenced, and it is possible to uniformly control the ion balance of the entire neutralization apparatus main body 10 in the lateral direction.

According to the first example, if plus ions and minus ions are generated in a state where the discharge needle 27 of the plus electrode 20 and the discharge needle 37 of the minus electrode 30 are opposed to each other at a short distance from each other, although the plus ions and minus ions approach each other by the suction effect, the plus ions and minus ions are simultaneously transferred to the subject to be neutralized 170 by the high speed gas injected from the hole having the diameter of 0.3 mm of the gas injection port 60, and it is possible to provide the DC bar-shaped neutralization apparatus 1 having fast neutralization time.

If the discharge needle 27 of the plus electrode 20 and the discharge needle 37 of the minus electrode 30 are opposed to each other at the short distance from each other, the high voltage ±V_{H} for generating ions can be lowered to ±3 kV. Since the applied high voltage is lowered, it is possible to reduce the wearing amount of the discharge needle caused by the spatter phenomenon and to reduce the amount of particles attached to the tip end of the discharge needle. Further, since the voltage is lowered, the danger of high voltage leakage in the bar main body is largely reduced, and the lifetime of the product can be increased.

The generated plus ions and minus ions in the air move between the electrodes where there are air injection ports by the effect of attraction force of the ions because the distance a between the electrodes is short.

The plus ions and minus ions which moved in between the electrodes are simultaneously transferred to the subject to be neutralized by the high speed gas flow injected from the port having the diameter of 0.3 mm. Therefore, it is possible to supply the plus ions and minus ions with excellent balance.

In the present invention, because the conductive plates made of SUS having the thickness of 0.3 mm are pasted on both surfaces of the bar main body, the induction charging value of the bar main body side surface by the discharge electrode is uniformed, the ion balance is measured by the three ion balance sensors located at the center and both ends of the bar, and the ion balance is controlled by the ion balance control circuit. Accordingly, the gradient of the ion balance in the longitudinal direction of the bar can be suppressed to ±10V, and the balance can be uniformed substantially.

The embodiments of the present invention have been explained. However, the invention can be variously modified.

For example, if a plurality of inclination angles θ of the plus electrode 20, the minus electrode 30, the end plus electrode 40, and the end minus electrode 50, i.e., 15°, 30°, 45°, and 60° are prepared, the neutralization apparatus 1 can be constituted by mounting the plus electrode 20, the minus electrode 30, the end plus electrode 40, and the end minus electrode 50 having optimal inclination angles 0 as required, and, it is possible to increase the number of product variations.

Although it has been explained that the embodiments do not have downflow, air supply means for supplying the downflow can be disposed on the neutralization apparatus 1 so that ions can reach the subject to be neutralized 170 more quickly.

1. A DC voltage corona discharging neutralization apparatus comprising
a neutralization apparatus main body;
a plurality of plus electrodes which are provided in the neutralization apparatus main body and to which plus voltage is applied to generate plus ions,
a plurality of minus electrodes which are provided in the neutralization apparatus main body and to which minus voltage is applied to generate minus ions, and
a plurality of gas injection ports which are formed in the neutralization apparatus main body and from which gas flow for transferring ions is injected, wherein
the gas injection ports are provided between the plus electrodes and the minus electrodes.

2. The neutralization apparatus according to claim 1, further comprising
a metal conductive plate which is made of metal and which is not grounded, wherein
the neutralization apparatus main body is made of insulative resin material, and the metal conductive plate covers outside of the neutralization apparatus main body.

3. The neutralization apparatus according to claim 1 or 2, further comprising
ion sensors which are disposed between the plus electrodes and the minus electrodes and which are provided in the neutralization apparatus main body, and which detect an ion balance state and output detection signals, and
a central processing unit which adjusts plus voltage applied to the plus electrodes and/or minus voltage to be applied to the minus electrodes to control the ion balance based on the detection signals from the ion sensors, wherein
the central processing unit adjusts the plus voltage to be applied to the plus electrodes and/or minus voltage to be applied to the minus electrodes according to the detection signals, and adjusts the ion balance to zero balance.

4. The neutralization apparatus according to claim 3, further comprising a setting unit which is connected to the central processing unit, and which sets a positive mode in which more plus ions than minus ions are generated or only plus ions are generated to bring the ion balance into an unbalanced state, or sets a negative mode in which more minus ions than plus ions are generated or only minus ions are generated to bring the ion balance into an unbalanced state, instead of a normal mode in which the ion balance is adjusted to zero balance, wherein
the central processing unit intentionally adjusts the plus ions and minus ions into the unbalanced state according to the positive mode or the negative mode.

5. The neutralization apparatus according to claim 1 or 2, wherein
the plus electrodes and the minus electrodes are respectively provided with discharge needles which are inclined toward the gas injection ports,
the gas flow is injected from each of the gas injection ports in a direction substantially perpendicular to the subject to be neutralized, and an extension of the discharge needle of the plus electrode and an extension of the discharge needle of the minus electrode intersect with each other on the gas flow.

6. The neutralization apparatus according to claim 3, wherein
the plus electrodes and the minus electrodes are respectively provided with discharge needles which are inclined toward the gas injection ports,
the gas flow is injected from each of the gas injection ports in a direction substantially perpendicular to the subject to be neutralized, and an extension of the discharge needle of the plus electrode and an extension of the discharge needle of the minus electrode intersect with each other on the gas flow.

7. The neutralization apparatus according to claim 5, wherein
each of the ion sensors is of a rod-like shape, a straight shaft direction of the ion sensor is parallel to a gas injection direction, and the straight shaft of the ion sensor is mounted such that the extension of the discharge needle of the plus electrode and the extension of the discharge needle of the minus electrode intersect with each other.

8. The neutralization apparatus according to claim 6, wherein
each of the ion sensors is of a rod-like shape, a straight shaft direction of the ion sensor is parallel to a gas injection direction, and the straight shaft of the ion sensor is mounted such that the extension of the discharge needle of the plus electrode and the extension of the discharge needle of the minus electrode intersect with each other.

9. The neutralization apparatus according to claim 1 or 2, wherein
both the plus electrode and minus electrode have the same mechanical structures,
each of the plus electrode and the minus electrode includes
an electrode holder which is an electrical insulator and which is mechanically connected to the neutralization apparatus main body,
a conductive portion disposed in the electrode holder, and
two discharge needles which are electrically connected to the conductive portion, and wherein
the two discharge needles are inclined in a form of a A-shape.

10. The neutralization apparatus according to claim 1 or 2, wherein
an end plus electrode and an end minus electrode disposed on ends have the same mechanical structures,
each of the end plus electrode and end minus electrode includes
an electrode holder which is an electrical insulator and which is mechanically connected to the neutralization apparatus main body,
a conductive portion disposed in the electrode holder, and
one discharge needle which is electrically connected to the conductive portion, and wherein
the one discharge needle is inclined toward the gas injection port.
